(19) United States
(12) Patent Application Publication
(10) Pub. No.: US 2007/0289411 A1
(43) Pub. Date: Dec. 20, 2007

(54) Wall-Mounted Corkscrew

(75) Inventor: Santiago Olaneta Arambarri, Eibar (Guipuzcoa) (ES)

Correspondence Address: LUCAS & MERCANTI, LLP, 475 PARK AVENUE SOUTH, 15TH FLOOR, NEW YORK, NY, 10016, US

(73) Assignee: B. OLANETA Y JUARISTI, S.A., EIBAR (GUIPUZCOA) (ES)

(21) Appl. No.: 11/572,672

(22) PCT Filed: May 25, 2005
(86) PCT No.: PCT/ES05/00294

§ 371 Date: Jan. 25, 2007

(30) Foreign Application Priority Data
Jul. 29, 2004 (ES) U200401840

(51) Int. Cl. B67B 7/04

(52) U.S. Cl. 81/3.47

(57) ABSTRACT

The invention relates to a wall-mounted corkscrew comprising a mechanism which includes the helical shaft to be inserted into the cork and which is connected to an actuating lever. The aforementioned mechanism is housed inside a one-piece tubular body which is closed at one end and said mechanism comprises a plastic cylindrical part (15) in which a helical-shaft-bearing screw (2) is positioned with an axial freedom of movement. In addition, a backstop is disposed between a striction (7) inside the part (15) and a transverse shaft (8) which passes therethrough.

### FIELD OF THE INVENTION

The present invention relates to corkscrews arranged in a mounting area and having a lever by means of which a mechanism including the helical shaft for removing the cork is actuated, providing an embodiment of said corkscrews with features that improve the operation and construction thereof.

### STATE OF THE ART

Corkscrews in a fixed assembly include the helical shaft for removing the cork associated to a mechanism which is housed in a tubular body and which is actuated by means of an actuation lever, the tubular body being provided with an upper cover which can be removed for the assembly of the inner mechanism. This embodiment is expensive to manufacture since the tubular body and the cover must be made separately, the fitting of a threaded coupling between necessary being later adapted.

The shaft-bearing mechanism comprises a screw including the helical shaft, said screw passing through a rotating actuation nut, whereas at the rear end it is associated to a longitudinal drive part in relation to which it is axially retained with the freedom to rotate. In conventional corkscrews of this type, the drive part of the mechanism is metallic and is made by machining, which involves a high constructive manufacturing cost, further making the corkscrew very heavy.

This type of corkscrew is normally wall-mounted in a vertical position on a wall and the actuation lever thereof is usually left in a raised position so that it does not get in the way when it is not being used, and therefore there is a risk that said lever will lower by itself, possibly causing accidents; therefore in the construction of such corkscrews it is necessary to include some provisional retention means for the lever in the mentioned upper position.

The position of the lever in the raised situation furthermore usually involves a drawback for the gripping thereof when actuating the corkscrew due to the little space between said lever and the mounting wall of the corkscrew.

### OBJECT OF THE INVENTION

A corkscrew of the mentioned type is proposed according to the present invention but which is structured such that it effectively resolves the drawbacks of the conventional embodiments of this type of corkscrew, providing very advantageous functional features.

This corkscrew object of the invention is formed by a tubular body in which the helical-shaft-bearing mechanism for being inserted in corks is housed, said tubular body being formed by a one-piece structural assembly closed at the upper end, whereas the helical-shaft-bearing mechanism comprises a molded drive part made of plastic.

A corkscrew is thus obtained the constructive embodiment of which is simplified in relation to conventional corkscrews since the tubular body only requires a molding operation and does not include threaded parts that have to be adjusted, whereas the drive part of the helical-shaft-bearing mechanism also has an advantageous manufacture due to its being made of plastic and molded, compared to the equivalent metal part which is made by machining included in conventional corkscrews of this type.

Said drive part of the plastic helical-shaft-bearing mechanism has a tubular shape with a transverse hole for the passage of the coupling shaft of the operating lever, the inner axial space of said part having a striction at one end in relation to which the back head of the screw associated to the helical shaft works as a stop in the assembly, whereas in the opposite direction said assembly is retained by the transverse coupling shaft of the lever, between the latter and the head of the screw a ball enabling rotation is included.

A mounting arrangement is thus obtained without any threads or retention mechanisms for holding the head of the screw in the drive part of the mechanism such that the mounting only requires introducing the screw through the inner space of the drive part and the support ball after it, the coupling shaft of the lever then passing through the transverse hole, the back head of the screw thereby being in the mounting arrangement in relation to the drive part of the mechanism of the corkscrew.

A magnet has been provided in the inner end part of the tubular body of the corkscrew, which magnet can form a magnetic retention in relation to any metal part of the moving mechanism, thus allowing by means of a simple arrangement ensuring the position of the assembly of the corkscrew with the raised actuation lever, preventing the latter from accidentally lowering.

Additionally, the side grooves of the tubular body of the corkscrew through which the transverse coupling shaft of the lever passes in the movement of the mechanism are provided with an upper end working as a stop for the mentioned moving transverse shaft before the actuation lever reaches the vertical raised position, said lever thereby being in the slightly forwardly inclined upper stop position, thus being appropriately separated from the mounting wall of the corkscrew so as to be easily gripped.

Therefore said corkscrew object of the invention has very advantageous features, being feasible and preferred in relation to known corkscrews of the same type.

### DESCRIPTION OF THE FIGURES

FIG. 1 shows a perspective view of the outer assembly of a corkscrew according to the invention.

FIG. 2 shows an exploded perspective view of a wall-mounted corkscrew mechanism according to the conventional embodiment.

FIG. 3 shows an exploded perspective view of the corkscrew mechanism object of the invention.

FIG. 4 shows an enlarged sectional detail of the mounted conventional corkscrew mechanism.

FIG. 5 shows an enlarged sectional detail of the corkscrew mechanisms of the mounted invention.

FIG. 6 shows an enlarged sectional detail of the upper end of the tubular body of the corkscrew object of the invention.

FIG. 7 shows a side view of the corkscrew of the invention in the application arrangement on a wall.

### DETAILED DESCRIPTION OF THE INVENTION

The object of the invention relates to a corkscrew of the type fixed to a wall or a similar area for their use, proposing a constructive embodiment improving the functional and structural features of said corkscrews.

A corkscrew of this type consists of a tubular body (1) inside of which a mechanism is housed comprising a screw (2) in relation to which the helical shaft (3) is coupled and intended for being inserted in corks to be extracted, being able to actuate the movement mechanism by means of an actuation lever (4).

The screw (2) of the mechanism is coupled to a drive part (5) in relation to which it is axially retained with freedom of rotation, further passing through a nut (6) which is provided in a guided assembly by means of rods (7) in relation to the drive part (5), provided with an axial freedom of movement between both parts but without the ability of rotation between them.

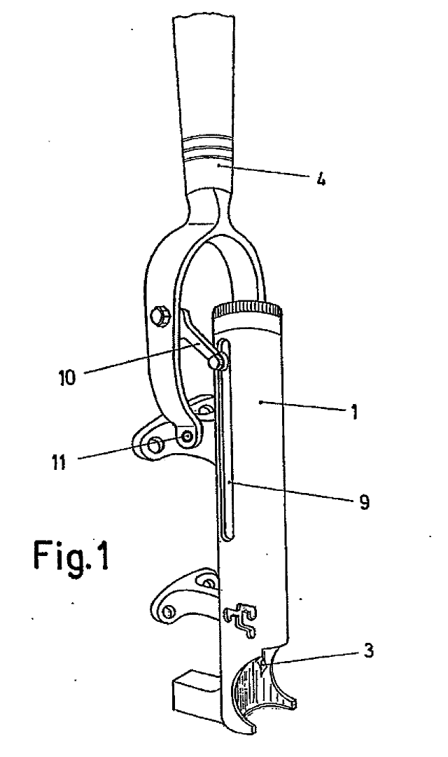

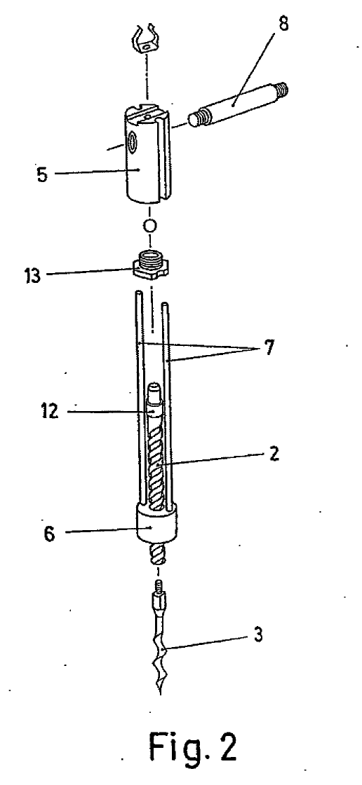

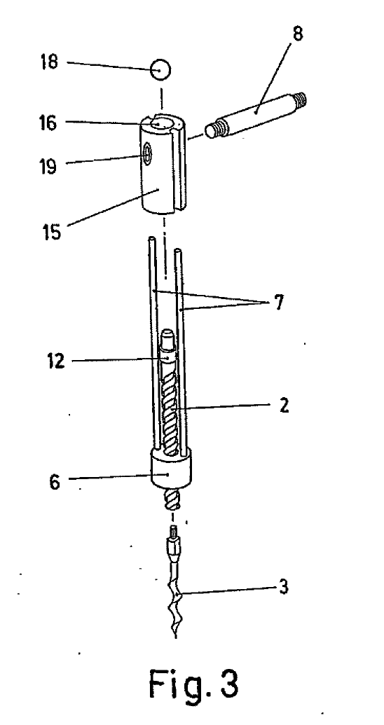

The drive part (5) is furthermore traversed by a transverse shaft (8) projecting out through lateral grooves (9) of the tubular body (1), the actuation lever (4) being joined at its ends by means of connecting rods (10), the lever furthermore pivoting on a rotation point (11), as can be observed in FIG. 1.

In these conditions, when the lever (4) is lowered, it drives part (5) downwards by means of the shaft (8), which part takes with it in this movement the screw (2) and the nut (6) until the latter is supported against an inner stop of the tubular body (1), at which time the part (5) continues to drive the screw (2) in axial movement, said screw (2) then being forced to rotate due to its sliding passage through the nut (6), the helical shaft (3) thereby advancing and rotating in a combination of movement allowing the insertion in corks to be extracted.

In a subsequent upward swiveling of the lever (4), the part (5), the screw (2) and the nut (6) are driven together until the rods (7) abut against the closed upper end of the body (1), at which time the driving of the screw (2) by the part (5) determines a rotation of said screw (2), the helical shaft (3) exiting the corresponding cork which up until that time it had been extracting from the bottle to be opened.

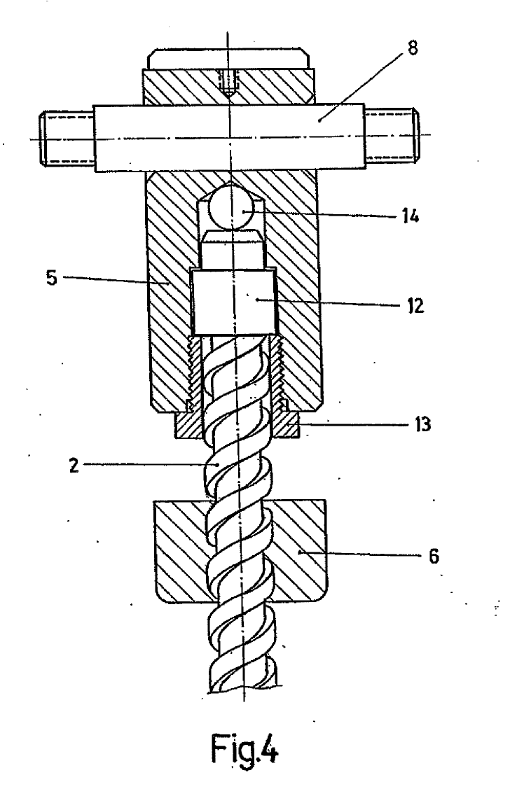

In the convention embodiment of corkscrews of this type, the drive part (5) of the mechanism is a metal part made by machining and is defined according to a partially hollow configuration, as shown in FIG. 4, such that the screw (2) of the mechanism is coupled with said part (5) by axial encasing therein by means of a head (12) and retention with a stop nut (13), the head (12) being supported in the inner part on a ball (14) enabling rotation.

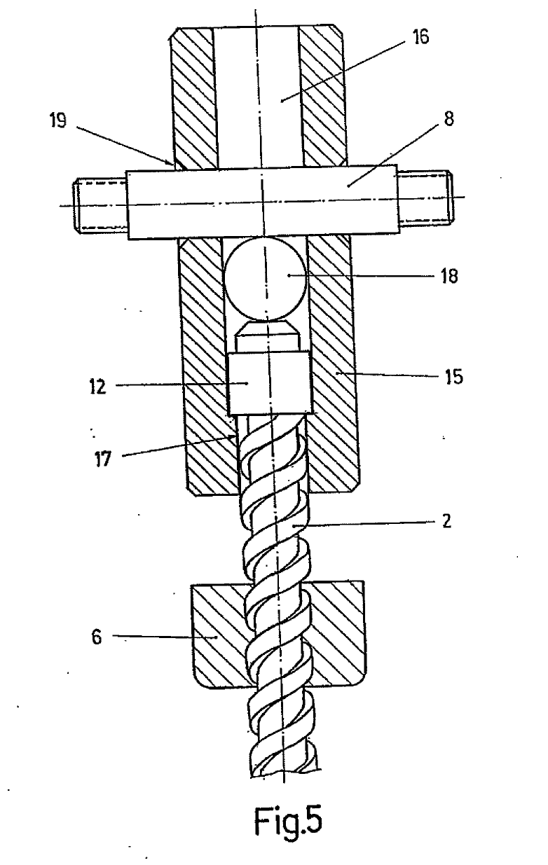

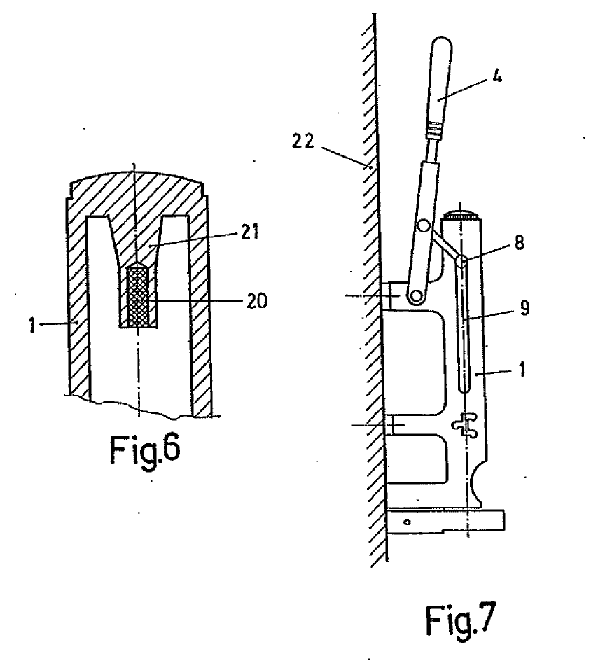

According to the invention, the corkscrew mechanism is formed with a molded plastic drive part (15) carried out according to an axially hollow configuration in the entire assembly, as shown in FIG. 5, said part (15) defining an inner space (16) the latter defining a striction (17) at one of the ends.

Therefore the helical-shaft-bearing screw (2) to be inserted in corkscrews is introduced in the mentioned part (15) passing through the striction (17), such that the head (12) of said screw (2) is housed in the space (16), abutting against the mentioned striction (17) preventing the exit therefrom at this end.

A subsequent blocking is formed in this case by means of introducing the transverse shaft (8), in turn preventing the exit of the head (12) of the screw (2) at the other end of the part (15), a retention coupling of said head (12) of the screw (2) thereby resulting in relation to the mentioned part (15) in the same practical conditions for the operation of the mechanism as in the case of the part (5) in a conventional embodiment, but in this case dispensing with the retention nut (13) and with an easier to assemble arrangement, in addition to the manufacturing and weight advantages provided with the plastic part (15).

A ball (18) working as a stop for the head (12) of the screw (2) is also included in this embodiment so as to enable rotation, said ball (18) having a diameter which coincides with the diameter of the inner space (16) of the part (15) so as to be housed in a sliding manner in said space (16) but without being able to pass through the passage holes (19) of the shaft (8), the assembly thereby being very easy to carry out.

According to the invention, the tubular body (1) of the corkscrew is structurally formed in a single piece with the upper end closed, a magnet (20) being arranged in the inner part of said closed upper end, such magnet intended to form a provisional magnetic retention of the corkscrew mechanism when it is located in the upper position, i.e. when the actuation lever (4) is swiveled upwards, thus preventing said lever (4) from accidentally lower by itself to the lowered position.

According to a practical embodiment, the magnet (20) is encased in an axial projection (21) of the inside of the closed end of the tubular body (1) such that the end of said projection (21) through which the magnet (20) projects makes contact with the metal transverse shaft (8) when the corkscrew mechanism moves to the upper position, thus producing the provisional holding by magnetic retention to prevent the lever (4) from accidentally lowering from the raised position.

Said embodiment is not limiting since other types of assemblies can be formed with the same result of magnetic retention, for example arranging a magnet (20) in the upper bottom of the closed end of the body (1) and arranging metal incrustations in the plastic part (15), thereby obtaining, by magnetic effect, a provisional retention in the same way of the moving mechanism in the upper position to prevent the lever (4) from accidentally lowering from the raised position to the lowered position.

The actuation of the corkscrew is carried out by operating the lever (4) which is close to the mounting wall (22) of the corkscrew in the raised position, such that an upper limit of the side grooves (9) of the tubular body (1) is provided in a position in which the transverse shaft (8) abuts against it before the lever (4) reaches the vertical position so as to enable introducing the fingers behind the lever (4) without grazing the wall (22), therefore in the raised limit position said lever (4) is slightly forwardly inclined, as shown in FIG. 7, in a position in which it is easy to grip it with the hand without grazing the wall (22).

1. A wall-mounted corkscrew of the type consisting of a tubular body (1) inside of which there is housed a moving mechanism which can move axially by means of an actuation lever (4), which mechanism is associated by means of a screw (2) to the helical shaft (3) to be inserted in corks, wherein the tubular body (1) housing the mechanism is a one-piece body closed at the upper end and in that the moving mechanism comprises a plastic drive part (15) which defines an axial through space (16) in its entire length with a striation (17) at one end, internally housing a back head (12) of the screw (2), which head abuts against the striation (17) and is retained at the other part by means of a transverse shaft (8) related to the actuation lever (4).

2. An improved wall-mounted corkscrew according to claim 1, further comprises a stop ball (18) enabling rotation is arranged between the head (12) of the screw (2) and the transverse shaft (8).

3. A wall-mounted corkscrew according to claim 2, wherein the ball (18) is housed in a sliding manner in the space (16) of part (15) with a larger diameter than that of the passage holes (19) of the transverse shaft (8) through said part (15).

4. A wall-mounted corkscrew according to claim 1, further comprises a magnet (20) is arranged in the inner part of the blind upper end of the tubular body (1), which magnet can form a magnetic retention for provisionally holding the moving mechanism in the upper position with the actuation lever (4) raised.

5. A wall-mounted corkscrew according to claim 4, wherein the magnet (20) acts with the transverse shaft (8) to form the magnetic retention for holding the mechanism in the upper position.

6. A wall-mounted corkscrew according to claim 4, wherein the magnet (20) acts with metal incrustations included in the plastic part (5) to form the magnetic retention for holding the mechanism in the upper position.

7. A wall-mounted corkscrew according to claim 1, further comprises side grooves (9) are provided in the tubular body (1) for the sliding of the transverse shaft (8), which grooves define an upper limit working as a stop for said transverse shaft (8) in the raised slightly forwardly inclined position of the actuation lever (4).
